(19) United States
(12) Patent Application Publication
(10) Pub. No.: US 2008/0244138 A1
(43) Pub. Date: Oct. 2, 2008

(54) MICROCOMPUTER

(75) Inventor: Hirofumi Terasawa, Okaya-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/053,194

(22) Filed: Mar. 21, 2008

(30) Foreign Application Priority Data
Mar. 29, 2007 (JP) 2007-086806
Jul. 3, 2007 (JP) 2007-174857

(51) Int. Cl. G06F 13/24

(52) U.S. Cl. 710/264

(57) ABSTRACT

A microcomputer includes a plurality of processing circuits for executing a plurality of interrupt processes each corresponding to one of a first plurality of causes) a cause register circuit for representing whether each of the first plurality of causes has been solved or unsolved, a processing circuit selection register for defining a plurality of correspondences each between one of the first plurality of causes and one of the plurality of processing circuits responsible to execute one the interrupt processes corresponding to the one of the first plurality of causes, and for outputting, in response to occurrence of one of the causes, to the plurality of processing circuits an interrupt signal representing that one of the interrupt processes should be executed, a vector signal indicating an area in which a content of the one of the interrupt processes corresponding to the one of the causes, and a first selection signal representing which one of the processing circuits should execute the one of the interrupt processes corresponding to the one of the causes, and a processing circuit selection circuit for outputting, in response to the first selection signal, to the processing circuit indicated by the first selection signal, a second selection signal representing that the processing circuit is selected.

The entire disclosure of Japanese Patent Application Nos: 2007-086806, filed Mar. 29, 2007 and 2007-174857, filed Jul. 3, 2007 are expressly incorporated by reference herein.

### BACKGROUND OF THE INVENTION

1. Technical Field

Several aspects of the present invention relates to a microcomputer including a plurality of processing circuits (e.g., CPU) for performing a plurality of interrupt processes corresponding to a plurality of causes.

2. Related Art

In a microcomputer M100 of the related art shown in FIG. 6, when either one (e.g., a cause F1) of causes F1 through Fi occurs, a first interrupt controller 100 (composed mainly of a cause register circuit 110, a mask circuit 120, and a priority circuit 130), to which the causes F1 through Fi are assigned, outputs to a first processing circuit A an interrupt signal representing that an interrupt process corresponding to the cause F1 should be executed, and a vector signal indicating an address (a top address) of an location on a first memory circuit 300, in which a content of the interrupt process is stored. In response to receiving the interrupt signal and the vector signal, the first processing circuit A executes the interrupt process along the content of the interrupt process for the cause F1 stored in the area on the first memory circuit 300.

In the microcomputer M100 of the related art described above, the interrupt processes corresponding respectively to the causes F(i+1) through Fn are executed by a second interrupt controller 200, a second processing circuit B, and a second memory circuit 400 in cooperation with each other in the same manner as described above.

However, in the microcomputer M100 of the related art described above, since two interrupt controllers, namely the first and second interrupt controllers 100, 200 are necessary for the two processing circuits A, B, the circuit size becomes large, and as a result, it caused high price and increase in power consumption.

Further, since the causes F1 through Fi are fixedly (e.g., via wires) assigned to the first interrupt controller 100, and the causes F(i+1) through Fn are assigned fixedly to the second interrupt controller 200, there is a concern that the load of the interrupt processing by the first processing circuit A and the load of the interrupt processing by the second processing circuit B might be unbalanced.

### SUMMARY

According to a first aspect of the invention, there is provided a microcomputer including a plurality of processing circuits for executing a plurality of interrupt processes each corresponding to one of a first plurality of causes, a cause register circuit for representing whether each of the first plurality of causes has been solved or unsolved, a processing circuit selection register for defining a plurality of correspondences each between one of the first plurality of causes and one of the plurality of processing circuits responsible to execute one the interrupt processes corresponding to the one of the first plurality of causes, and for outputting, in response to occurrence of one of the causes, to the plurality of processing circuits an interrupt signal representing that one of the interrupt processes should be executed, a vector signal indicating an area in which a content of the one of the interrupt processes corresponding to the one of the causes, and a first selection signal representing which one of the processing circuits should execute the one of the interrupt processes corresponding to the one of the causes, and a processing circuit selection circuit for outputting, in response to the first selection signal, to the processing circuit indicated by the first selection signal, a second selection signal representing that the processing circuit is selected.

According to a second aspect of the invention, there is provided a microcomputer including a plurality of processing circuits for executing a plurality of interrupt processes each corresponding to one of a first plurality of causes, a cause register circuit for representing whether each of the first plurality of causes has been solved or unsolved, a processing circuit selection register for defining a plurality of correspondences each between one of the first plurality of causes and one of the plurality of processing circuits responsible to execute one of the interrupt processes corresponding to the one of the first plurality of causes, and for outputting, in response to occurrence of one of the causes, to the plurality of processing circuits an interrupt signal representing that one of the interrupt processes should be executed, and a vector signal indicating an area in which a content of the one of the interrupt processes corresponding to the one of the causes, a multiplexer circuit for outputting, in response to the vector signal, a first selection signal representing which one of the processing circuits should execute the one of the interrupt processes corresponding to the one of the causes, and a processing circuit selection circuit for outputting, in response to the first selection signal, to the processing circuit indicated by the first selection signal, a second selection signal representing that the processing circuit is selected.

According to the microcomputer related to the first and second aspects of the invention, the processing circuit selection circuit outputs the interrupt signal, the vector signal, and the second selection signal to the plurality of processing circuits by itself or in cooperation with the multiplexer circuit, thus it is possible to make the plurality of processing circuits execute the interrupt processes without using a plurality of interrupt controllers as in the related art, and as a result, the circuit size of the microcomputer is reduced in comparison with the related art, thus contribute a low price and low power consumption.

In addition, since which one of the plurality of processing circuits the plurality of causes are assigned to can be set by the processing circuit selection register circuit, the load of the interrupt processes can be balanced among the plurality of processing circuits.

According to a third aspect of the invention, there is provided a microcomputer including a plurality of processing circuits for executing a plurality of interrupt processes each corresponding to one of a first plurality of causes, a cause register circuit for representing whether each of the first plurality of causes has been solved or unsolved, a processing circuit selection register for defining a plurality of correspondences each between one of the first plurality of causes and one of the plurality of processing circuits responsible to execute one of the interrupt processes corresponding to the one of the first plurality of causes, a mask circuit for allowing reception of a second plurality of causes out of the first plurality of causes and inhibiting reception of the rest of the first plurality of causes, a priority circuit for (1) previously defining priorities with which two or more of the interrupt processes corresponding to tow or more of the causes are executed when the two or more of the causes included in the second plurality of causes reception of which is allowed by the mask circuit out of the first plurality of causes, and for (2) (2a) outputting to the plurality of processing circuits an interrupt signal representing that one of the interrupt processes should be executed, and a vector signal indicating an area in which a content of the interrupt process with the highest one of the priorities is defined, and (2b) outputting a first selection signal representing which one of the processing circuits should execute the interrupt process with the highest one of the priorities, and a processing circuit selection circuit for outputting, in response to the first selection signal, to the processing circuit indicated by the first selection signal, a second selection signal representing that the processing circuit is selected.

According to a fourth aspect of the invention, there is provided a microcomputer including a plurality of processing circuits for executing a plurality of interrupt processes each corresponding to one of a first plurality of causes, a cause register circuit for representing whether each of the first plurality of causes has been solved or unsolved, a processing circuit selection register for defining a plurality of correspondences each between one of the first plurality of causes and one of the plurality of processing circuits responsible to execute one of the interrupt processes corresponding to the one of the first plurality of causes, a mask circuit for allowing reception of a second plurality of causes out of the first plurality of causes and inhibiting reception of the rest of the first plurality of causes, a priority circuit for (1) previously defining priorities with which two or more of the interrupt processes corresponding to tow or more of the causes are executed when the two or more of the causes included in the second plurality of causes reception of which is allowed by the mask circuit out of the first plurality of causes, and for (2) outputting to the plurality of processing circuits an interrupt signal representing that one of the interrupt processes should be executed, and a vector signal indicating an area in which a content of the interrupt process with the highest one of the priorities is defined, a multiplexer circuit for outputting, in response to the vector signal, a first selection signal representing which one of the processing circuits should execute the interrupt process with the highest one of the priorities, and a processing circuit selection circuit for outputting, in response to the first selection signal, to the processing circuit indicated by the first selection signal, a second selection signal representing that the processing circuit is selected.

According to the microcomputer related to the third and fourth aspects of the invention, the processing circuit selection circuit outputs the interrupt signal, the vector signal, and the second selection signal to the plurality of processing circuits in cooperation with the priority circuit or with the priority circuit and the multiplexer circuit, thus it is possible to make the plurality of processing circuits execute the interrupt processes without using a plurality of interrupt controllers as in the related art, and as a result, the circuit scale of the microcomputer is reduced in comparison with the related art, thus contribute a low price and low power consumption.

In addition, since which one of the plurality of processing circuits the plurality of causes are assigned to can be set by the processing circuit selection register circuit, the load of the interrupt processes can be balanced among the plurality of processing circuits.

### BRIEF DESCRIPTION OF THE DRAWINGS

The invention will now be described with reference to the accompanying drawings, wherein like numbers refer to like elements.

FIG. 1 is a diagram showing a configuration of a microcomputer according to an embodiment.

FIGS. 2A through 2D are diagrams respectively sowing a cause register circuit, a CPU selection register circuit, a mask circuit, and a priority circuit.

FIG. 3 is a diagram showing a configuration of a microcomputer according to a first modified example.

FIG. 4 is a diagram showing a configuration of a microcomputer according to a second modified example.

FIG. 5 is a diagram showing a configuration of a microcomputer according to a third modified example.

FIG. 6 is a diagram showing a configuration of a microcomputer or the related art.

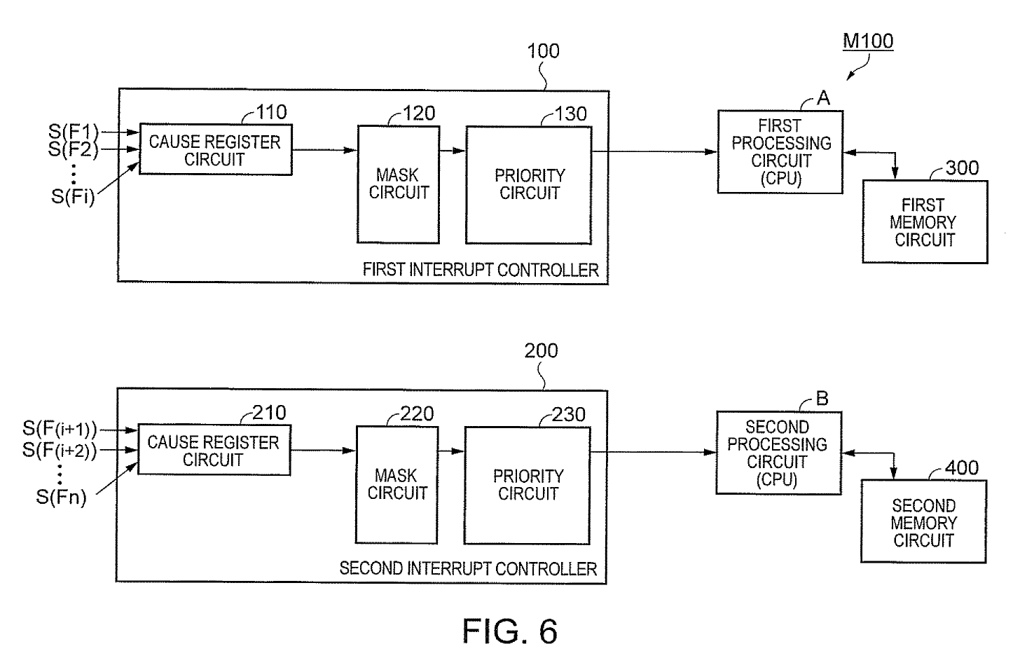

### DESCRIPTION OF EXEMPLARY EMBODIMENTS

Embodiments of a microcomputer according to the present invention will now be described with reference to the accompanying drawings.

### Embodiments

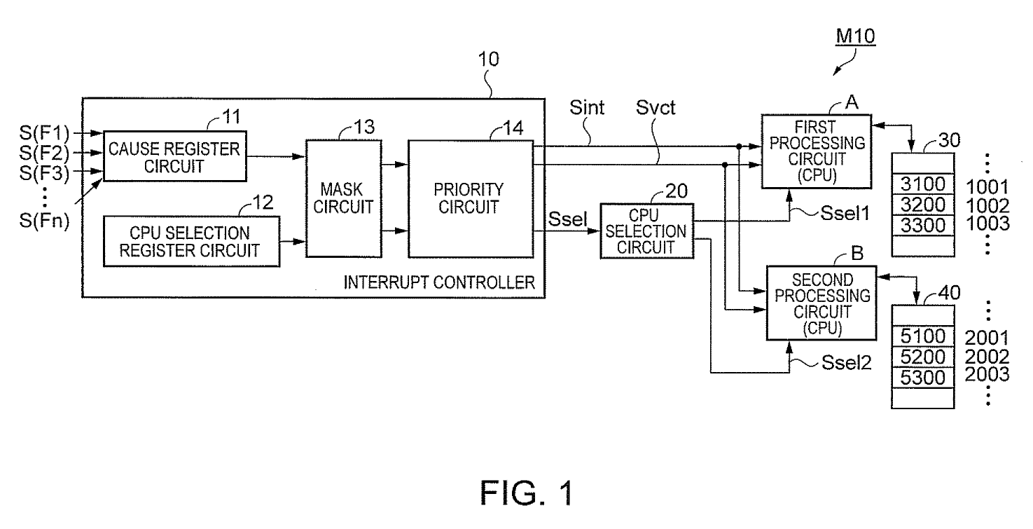

FIG. 1 shows a configuration of a microcomputer according to an embodiment. As shown in FIG. 1, a microcomputer M10 of the embodiment includes an interrupt controller 10, a CPU selection circuit 20, a first processing circuit (CPU) A, a second processing circuit (CPU) B, a first memory circuit 30, and a second memory circuit 40.

The interrupt controller 10 has a cause register circuit 11, a CPU selection register circuit 12, a mask circuit 13, and a priority circuit 14.

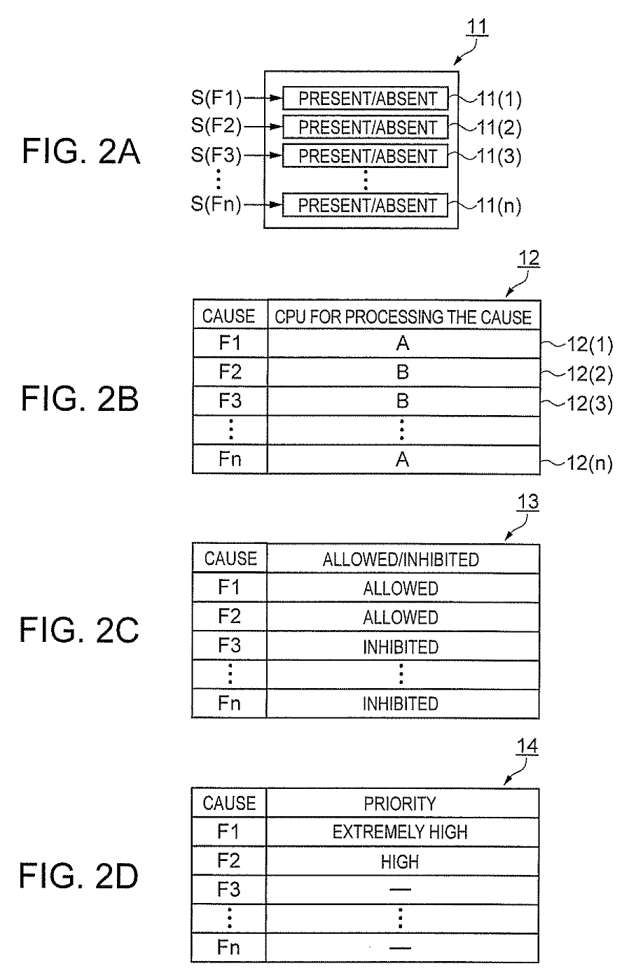

As shown in FIG. 2A, the cause register circuit 11 has a plurality of registers 11(1) through 11(n), and receives from the outside inputs of a plurality of cause occurrence signals S(F1) through S(Fn) respectively representing a plurality of causes (e.g., holding down the button, detection of temperature (both not shown), etc) F1 through Fn has occurred.

Hereinafter, for the sake of easier explanation and understanding, it is basically assumed the causes F1 and F2 have occurred.

In the cause register circuit 11, when the cause occurrence signal S(F1) representing the fact that the cause F1 has occurred, for example, is input, the cause register 11(1) is set to “EXIST” (unsolved) in response to the input of the cause occurrence signal S(F1). In a similar manner, when the cause occurrence signal S(F2) representing the fact that the cause F2 has occurred is input, the cause register 11(2) is set to “EXIST” in response to the input of the cause occurrence signal S(F2).

The cause register 11(1) thus set to “EXIST” is, as described later, set (cleared) to “NOT EXIST” (solved) by the first processing circuit A when the first processing circuit A completes the interrupt process corresponding to the cause F1. In a similar manner, the cause register 11(2) thus set to “EXIST” is, as described later, set to “NOT EXIST” by the second processing circuit B when the second processing circuit B completes the interrupt process corresponding to the cause F2.

The CPU selection register circuit 12 is “a processing circuit selection register circuit,” and, as shown in FIG. 2B, previously defines the correspondence between the causes F1 through Fn and the CPU (the first processing circuit A and the second processing circuit B) responsible to process the causes F1 through Fn, more precisely, the CPU responsible to execute the interrupt processes corresponding to the causes F1 through Fn. The CPU selection register 12 defines that when the cause F1 occurs, the interrupt process for the cause F1 should be executed by the first processing circuit A, and that when the cause F2 occurs, the interrupt process for the cause F2 should be executed by the second processing circuit B.

As shown in FIG. 2C, the mask circuit 13 previously defines that the causes F1 through Fn are ALLOWED/INHIBITED, in further detail, whether the interrupt processes corresponding respectively to the causes F1 through Fn are ALLOWED or INHIBITED. The mask circuit 13 defines, for example, that the interrupt processes corresponding to the causes F1, F2, F3, . . . , and Fn are respectively “ALLOWED,” “ALLOWED,” “INHIBITED,” . . . , and “INHIBITED.”

For example, when the causes F1, F2, and F3 occur, since the interrupt process corresponding to the cause F1 and the interrupt process corresponding to F2 are “ALLOWED,” as a result, the former interrupt process can be executed by the first processing circuit A, while the latter interrupt process can be executed by the second processing circuit B. In contrast, since the interrupt process corresponding to the cause F3 is “INHIBITED,” the interrupt process is never executed even by the second processing circuit B (see FIG. 2B) assigned to execute the interrupt process.

As shown in FIG. 2D, the priority circuit 14 defines the priorities (the order of precedence) of the causes F1 through Fn, in more detail, of the interrupt processes corresponding respectively to the causes F1 through Fn. The priority circuit 14 defines, for example, that the priorities of the interrupt processes corresponding to the causes F1, F2 are “EXTREMELY HIGH” and “HIGH,” respectively.

Going back to FIG. 1, the priority circuit 14 outputs to both of the first and second processing circuits A and B an interrupt signal Sint representing that either one of the interrupt processes corresponding to the causes F1 through Fn should be executed, in other words, that necessity of execution of some kind of interrupt process has arisen, and a vector signal Svct indicating the top address of the area in which the content of the interrupt process is stored. In addition thereto, the priority circuit 14 outputs to the CPU selection circuit 20 a first selection signal Ssel representing which one of the first and second processing circuit A and B should execute the interrupt process.

In more detail, if the causes F1 and F2 which “ALLOWED” by the mask circuit 13 have occurred, for example, the priority circuit 14 refers to “the fact that the interrupt process corresponding to the cause F1 should be executed by the first processing circuit A” and “the fact that the interrupt process corresponding to the cause F2 should be executed by the second processing circuit B” previously defined in the CPU selection register circuit 12, and the fact that “the cause F1 has an “EXTREMELY HIGH” priority” and the fact that “the cause F2 has a “HIGH” priority” previously defined in the priority circuit 14, thereby judging that the cause F1 should have priority over the cause F2, in other words, the interrupt process corresponding to the cause F1 should have priority over the interrupt process corresponding to the cause F2, and moreover, the first processing circuit A should be made execute the interrupt process corresponding to the cause F1. As a result of the judgment, the priority circuit 14 outputs the first selection signal Ssel representing that the first processing circuit A should be selected to the CPU selection circuit 20.

The CPU selection circuit 20, in response to receiving the first selection signal Ssel from the priority circuit 14, performs either one of outputting a second selection signal Ssel1 to the first processing circuit A and outputting a second selection signal Ssel2 to the second processing circuit B in accordance with the content designated by the first selection signal Ssel. In response to receiving the first election signal Ssel representing that the first processing circuit A should be selected, as described above, for example, the CPU selection circuit 20 outputs to the first processing circuit A the second selection signal Ssel1 representing that the first processing circuit A is selected.

The first processing circuit A and the second processing circuit B execute the interrupt processes corresponding to the causes F1 through Fn based on the contents of the interrupt processes stored in the first memory circuit 30 and the second memory circuit 40.

For example, when the first processing circuit A receives from the priority circuit 14 the interrupt signal Sint representing that necessity of execution of some kind of interrupt process has arisen and the vector signal Svct indicating an address “1001” on the first memory circuit 30 in which the content of the interrupt process corresponding to the cause F1 is stored as described above, and further receives from the CPU selection circuit 20 the second selection signal Ssel1 representing that the first processing circuit A is selected as described above, the process of the first processing circuit A jumps to a destination address “3100” to start executing the content of the interrupt process corresponding to the cause F1 stored on and after the address “3100.” When the execution of the interrupt process corresponding to the cause F1 is completed, the first processing circuit A sets (clears) the cause register 11(1) in the cause register circuit 11, which has been set to “EXIST,” to “NOT EXIST.”

As described above, in the microcomputer M10 according to the embodiment, when the causes F1, F2 “ALLOWED” by the mask circuit 13 and given priority to the cause F1 over the cause F2 occur, the priority circuit 14 outputs to the first and second processing circuits A and B the interrupt signal Sint representing that necessity of execution of some kind of interrupt process has arisen, and the vector signal Svct indicating the address of the area in which the interrupt process corresponding to the cause F1, and further outputs the first selection signal Ssel representing that the interrupt process should be executed by the first processing circuit A to the CPU selection circuit 20 in accordance with the content defined by the priority circuit 14 to cause the CPU selection circuit 20 to output the second selection signal Ssel1 representing that the first processing circuit A has been selected to the first processing circuit A, thereby the first processing circuit A performs the interrupt process corresponding to the cause F1. Therefore, the circuit scale can be reduced in comparison with the microcomputer M100 in the related art required to have two interrupt controllers 100, 200, and as a result, a low price and low power consumption can be achieved.

Further, since which one of the first and second processing circuits A, B should execute the interrupt processes corresponding to the causes F1 through Fn can be changed only by changing the settings of the CPU selection register circuit 12, in contrast to the microcomputer M100 in the related art, it becomes possible to easily balance the load of the interrupt processes between the first and second processing circuits A, B.

### FIRST MODIFIED EXAMPLE

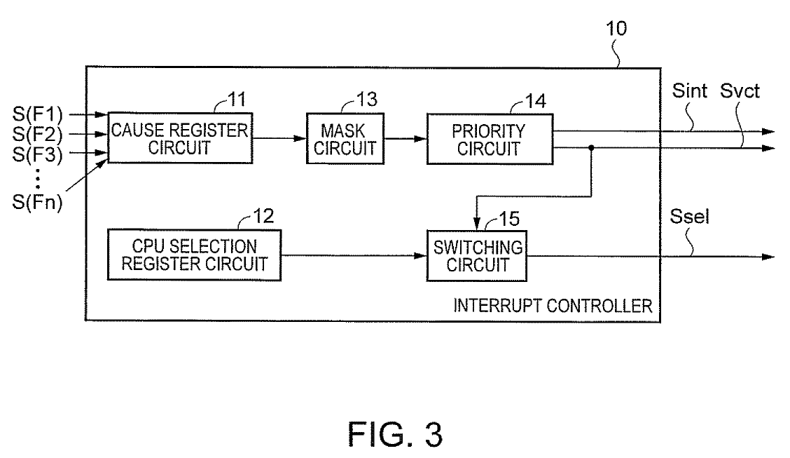

As shown in FIG. 3, in the interrupt controller 10 of the first modified example replacing the interrupt controller 10 (shown in FIG. 1) of the embodiment described above, the priority circuit 14 outputs the vector signal Svct to a switching circuit 15 in addition to the first processing circuit A and the second processing circuit B, and the switching circuit 15 learns that the interrupt process is corresponding to the cause F1 based on the address indicated by the vector signal Svct, the address “1001,” for example, and as a result, outputs the first selection signal Ssel representing that the first processing circuit A should be selected to the CPU selection circuit 20. According also to such a configuration as described above, the same advantages as described above can be obtained.

### SECOND MODIFIED EXAMPLE

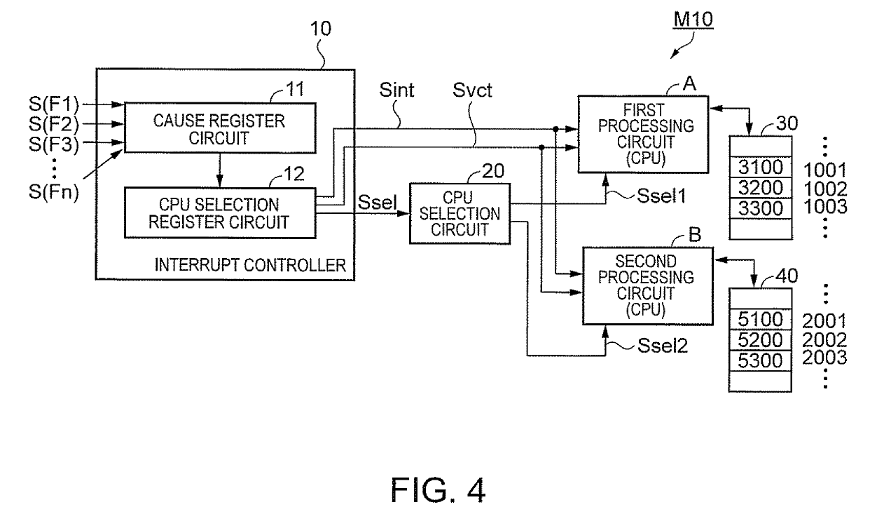

As shown in FIG. 4, the interrupt controller 10 of the second modified example replacing the interrupt controller 10 (shown in FIG. 1) of the embodiment described above includes only the cause register circuit 11 and the CPU selection register circuit 12, and in other words, does not include the mask circuit 13 and the priority circuit 14.

The cause register circuit 11 of the second modified example has the same configuration and the same function as those of the cause register circuit 11 of the embodiment described above on the one hand, and the CPU selection register circuit 12 of the second modified example has the same configuration as the CPU selection register circuit 12 of the embodiment described above, but has a different function therefrom, on the other hand.

Specifically, in the interrupt controller 10, when the cause register 11(1) in the cause register circuit 11 is set to “EXIST” (unsolved) in response to the input of the cause occurrence signal S(F1) representing that the cause F1 has occurred as shown in FIG. 2A, for example, the CPU selection register 12 refers to the correspondence (shown in FIG. 2B) between the cause, which has occurred, and the CPU, which should execute the interrupt process corresponding to the cause.

As a result, the CPU selection register 12 learns that the interrupt process corresponding to the cause F1 should be executed by the first processing circuit A, and further outputs the interrupt signal Sint, the vector signal Svct, and the first selection signal Ssel representing that the first processing circuit A should be selected, as a replacement for the priority circuit 14 of the embodiment described above. Then, by performing the same operation as in the embodiment described above, the same advantages as in the embodiment can be obtained.

### THIRD MODIFIED EXAMPLE

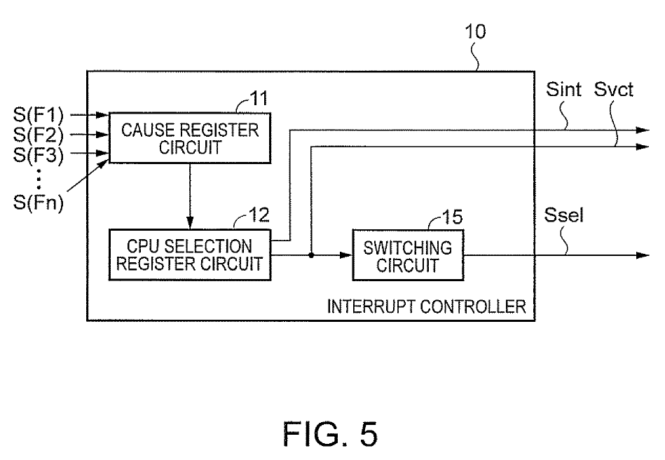

As shown in FIG. 5, the interrupt controller 10 of the third modified example replacing the interrupt controller 10 (shown in FIG. 3) of the first modified example described above includes the cause register circuit 11, the CPU selection register circuit 12, and the switching circuit 15 similarly to the first modified example, but does not include the mask circuit 13 and the priority circuit 14 in contrast to the first modified example.

In the interrupt controller 10 of the third modified example, when the cause register 11(1) in the cause register circuit 11 is set to “EXIST” (unsolved) in response to the input of the cause occurrence signal S(F1) representing that the cause F1 has occurred as shown in FIG. 2A, for example, the CPU selection register 12 refers to the correspondence shown in FIG. 2B.

As a result, the CPU selection register 12 learns that the interrupt process corresponding to the cause F1 should be executed by the first processing circuit A, and further outputs the interrupt signal Sint, the vector signal Svct, as a replacement for the priority circuit 14 of the embodiment described above.

The switching circuit 15, in response to receiving the vector signal Svct, outputs the first election signal Ssel representing that the first processing circuit A should be selected, similarly to the switching circuit 15 in the first modified example. Conclusively, the interrupt signal Sint, the vector signal Svct, and the first selection signal Ssel as described above are output from the interrupt controller 10, and by thereafter performing the same operation as in the first modified example, the same advantages as in the first modified example can be obtained.

What is claimed is:

1. A microcomputer comprising:
a plurality of processing circuits for executing a plurality of interrupt processes each corresponding to one of a first plurality of causes;
a cause register circuit for representing whether each of the first plurality of causes has been solved or unsolved;
a processing circuit selection register for defining a plurality of correspondences each between one of the first plurality of causes and one of the plurality of processing circuits responsible to execute one the interrupt processes corresponding to the one of the first plurality of causes, and for outputting, in response to occurrence of one of the causes, to the plurality of processing circuits an interrupt signal representing that one of the interrupt processes should be executed, a vector signal indicating an location in which a content of the one of the interrupt processes corresponding to the one of the causes, and a first selection signal representing which one of the processing circuits should execute the one of the interrupt processes corresponding to the one of the causes; and
a processing circuit selection circuit for outputting, in response to the first selection signal, to the processing circuit indicated by the first selection signal, a second selection signal representing that the processing circuit is selected.

2. A microcomputer comprising:
a plurality of processing circuits for executing a plurality of interrupt processes each corresponding to one of a first plurality of causes;
a cause register circuit for representing whether each of the first plurality of causes has been solved or unsolved;
a processing circuit selection register for defining a plurality of correspondences each between one of the first plurality of causes and one of the plurality of processing circuits responsible to execute one of the interrupt processes corresponding to the one of the first plurality of causes, and for outputting, in response to occurrence of one of the causes, to the plurality of processing circuits an interrupt signal representing that one of the interrupt processes should be executed, and a vector signal indicating an area in which a content of the one of the interrupt processes corresponding to the one of the causes;
a multiplexer circuit for outputting, in response to the vector signal, a first selection signal representing which one of the processing circuits should execute the one of the interrupt processes corresponding to the one of the causes; and
a processing circuit selection circuit for outputting, in response to the first selection signal, to the processing circuit indicated by the first selection signal, a second selection signal representing that the processing circuit is selected

3. A microcomputer comprising:
a plurality of processing circuits for executing a plurality of interrupt processes each corresponding to one of a first plurality of causes;
a cause register circuit for representing whether each of the first plurality of causes has been solved or unsolved;
a processing circuit selection register for defining a plurality of correspondences each between one of the first plurality of causes and one of the plurality of processing circuits responsible to execute one of the interrupt processes corresponding to the one of the first plurality of causes;
a mask circuit for allowing reception of a second plurality of causes out of the first plurality of causes and inhibiting reception of the rest of the first plurality of causes;
a priority circuit for (1) previously defining priorities with which two or more of the interrupt processes corresponding to two or more of the causes are executed when the two or more of the causes included in the second plurality of causes reception of which is allowed by the mask circuit out of the first plurality of causes, and for (2) (2a) outputting to the plurality of processing circuits an interrupt signal representing that one of the interrupt processes should be executed, and a vector signal indicating an area in which a content of the interrupt process with the highest one of the priorities is defined, and (2b) outputting a first selection signal representing which one of the processing circuits should execute the interrupt process with the highest one of the priorities; and
a processing circuit selection circuit for outputting, in response to the first selection signal, to the processing circuit indicated by the first selection signal, a second selection signal representing that the processing circuit is selected.

4. A microcomputer comprising:
a plurality of processing circuits for executing a plurality of interrupt processes each corresponding to one of a first plurality of causes;
a cause register circuit for representing whether each of the first plurality of causes has been solved or unsolved;
a processing circuit selection register for defining a plurality of correspondences each between one of the first plurality of causes and one of the plurality of processing circuits responsible to execute one of the interrupt processes corresponding to the one of the first plurality of causes;
a mask circuit for allowing reception of a second plurality of causes out of the first plurality of causes and inhibiting reception of the rest of the first plurality of causes;
a priority circuit for (1) previously defining priorities with which two or more of the interrupt processes corresponding to tow or more of the causes are executed when the two or more of the causes included in the second plurality of causes reception of which is allowed by the mask circuit out of the first plurality of causes, and for (2) outputting to the plurality of processing circuits an interrupt signal representing that one of the interrupt processes should be executed, and a vector signal indicating an area in which a content of the interrupt process with the highest one of the priorities is defined;
a multiplexer circuit for outputting, in response to the vector signal, a first selection signal representing which one of the processing circuits should execute the interrupt process with the highest one of the priorities; and
a processing circuit selection circuit for outputting, in response to the first selection signal, to the processing circuit indicated by the first selection signal, a second selection signal representing that the processing circuit is selected.
